(19) United States
(12) Patent Application Publication
(10) Pub. No.: US 2005/0276036 A1
(43) Pub. Date: Dec. 15, 2005

(54) Explorer lite extreme

(76) Inventors: Danny L. Miles, Herod, IL (US); Douglas R. Miles, Herod, IL (US)

Correspondence Address: DANNY L. MILES, BOX 133B, HEROD, IL, 62954, US

(21) Appl. No.: 10/866,585

(22) Filed: Jun. 14, 2004

(51) Int. Cl. F21V 21/084

(52) U.S. Cl. 362/105

(57) ABSTRACT

This product is a specially designed LED light used in hiking, exploring, and/or camping. This light is used primarily as a light to be worn on the head by means of adjustable elastic straps. The light system is powered by batteries located in a holding unit permanently affixed to the rear most section of the elastic head band harness. It has three additional attachments; a stand for a standing lamp use, a corrugated tense cover for lamp use, and a standard spotlight type of tense cover. This light has a four function, push-button switch; on-off, four bulbs, twelve bulbs, and twenty bulbs. This light system eliminates the use of additional carried equipment to accomplish the same results. It is extremely light in weight, durable, versatile, and emits a strong, long-lasting light source. It ensures hours of dependable light while exploring even the darkest of caves.

01. The design of the EXPLORER LITE EXTREME is primarily composed of a LED(light-emitting diode) light with a four function, push button switch, adjustable elastic straps, battery pack, and a three-piece accessary pack. A manufacture versed and aware of already existing materials, such as the elastic straps, can acquire and comprise the nessecary components to create this lighting system.

02. The light housing itself has the four function push button switch located on top of the housing. The switch is located equally spaced between the threads of the interchangeable lense covers and the rear base plate as it is in relation to a person's forehead while this device is being worn on the head.

03. The light housing contains a removable domed, durable lense. The lense completely encompasses the twenty, systematically spaced, LED bulbs and screws into place. The lense screws internally into the housing by means of matching and opposing threads. The treads are approximately 1/4 of an inch in depth. A secondary lense could also be constructed with a flat, instead of a domed, front surface, as to produce a more spot light like beam of light.

04. The light housing contains external threads as to attach one of the two interchangeable lense covers. One being a narrow, slightly convex, cover approximately two to two and a half inches in length, and with a very highly reflective interior surface. The other lense cover is a corrugated refracting surface as to emit a broad range of light, in either its hanging or standing lamp configurations.

05. The three adjustable elastic straps firmly hold this light system in place while being worn on a person's head. One strap goes up and over the person's head and contains a channel and small excess holding area for the two electrical wires that carry the current from the battery pack to the light source. The channel and excess holding area are also comprised of elastic strap material to effectively affirm the wire and adjustable amount of wire in place. The excess area is located at the rearmost, posterior end of the channel as to hold an adjustable amount of wire. The amount of wire can then be adjusted in complete relation to the adjustable length of the elastic strap to which it is attached. The two side straps follow in a left and right, horizontal path around the wearer's head. The adjusting buckles are all located in the front area of the lighting device so the wearer can easily adjust its fit accordingly. The three straps converge in the rear area of the light system on the rear baseplate of the battery holding box.

06. The battery box consists of three components, the baseplate that is permanently affixed to the elastic straps, the holding area of the batteries and wire connections, and the area that enables the light to be used in its lamp configurations. A small retaining screw is located appropriately to attach the baseplate to the remainder of the battery box. This enables the easy replacement of expired batteries.

07. The small raised area on the battery box is approximately one eighth of an inch in depth. This raised area that allows the light system to be used in its lamp configurations consists of two major components. The first is an U-shaped hinged hook that folds flush with the area's surface. The hinged hooked is securely held flush in place by two small retention knobs that interlock with two opposing retention notches. This hook enables the light system to be hung in it's hanging lamp configuration. The second component is a shallow retention hole located in the center of the raised area of the battery box. This retention hole enables a four-legged stand from the accessories pack to be affixed to the light system in it's standing lamp configuration.

08. The front light unit and the rear battery box can be attached to each other by three retention hook and tab closures. This union of the two pieces enables this light system to become one non-wearing lamp unit. In conjunction with its lamp stand accessory or it's hanging hook the now whole unit becomes a lamp. The retention tabs are located on the bottom and two sides of the front light baseplate. The hooks are located, in exact relation to the tabs, on the battery box.

09. The small accessory pack contains the four legged lamp stand and either one of the lense covers that is not in use. Its insides are constructed of a rugged, impact resistant material. The interior contains an impact resistant foam that securely and protectively holds the accessory pieces in place when not in use. The accessory pack is primarily made of two halves hinged together and secured in a closed position by a hook and tab closure or by any other array of subsequent type closures. This accessory pack comes equipped with a clip to attach the pack to either the belt or to some other place utilized by the user.

10. The colors, size specifications, or any of the other variables can be altered to accommodate the manufactures individual tastes of the invented light system, for example thirty LED bulbs instead of twenty.

### BRIEF DESCRIPTIONS OF THE DRAWINGS

FIG. 1 is a perspective representation of the EXPLORER LITE EXTREME from a frontal point of view.

FIG. 2 is a perspective representation of the EXPLORER LITE EXTREME from a posterior point of view.

FIG. 3 is a blown-up representation of the EXPLORER LITE EXTREME putting emphasis of the interior of the light housing, primarily the wire to switch and LED assembly, and the interior thread attachment of the light lense.

FIG. 4 is a blown-up representation of the EXPLORER LITE EXTREME putting emphasis of the exterior of the light housing, primarily the exterior threads for attachment of the light lense covers.

FIG. 5 is a perspective representation of the accessory pack and accessories of the EXPLORER LITE EXTREME.

FIG. 6 is a blown-up perspective representation of the hanging hook in its open position.

### DESCRIPTION OF THE PREFERRED EMBODIMENT

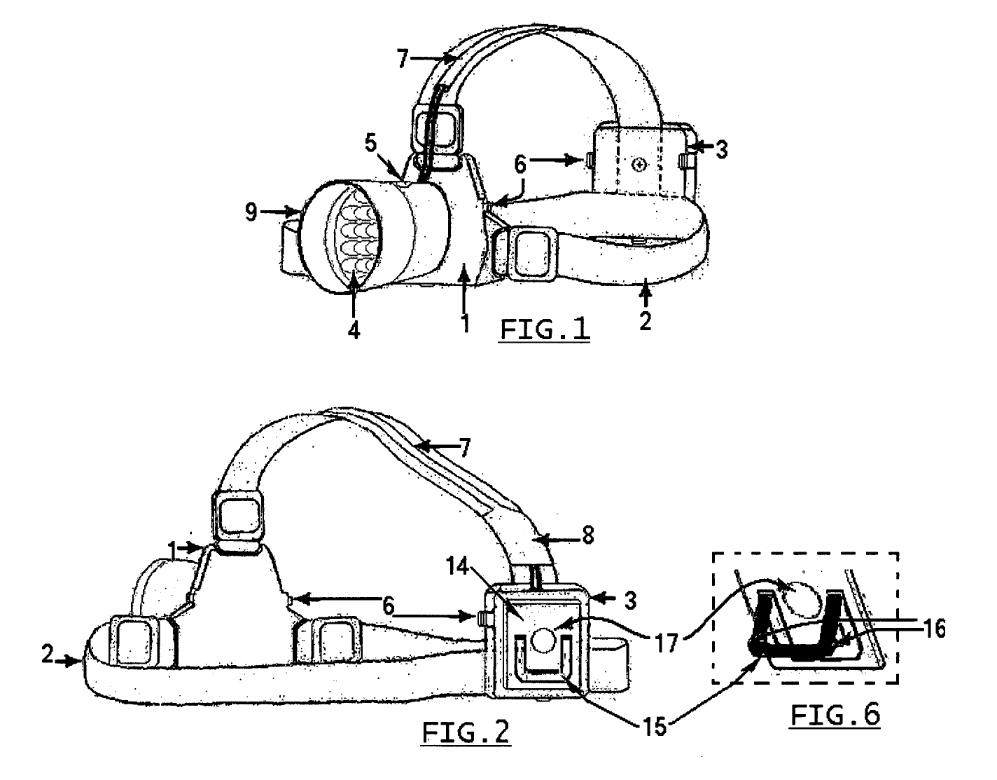

Now referring to FIG. 1 and FIG. 2 as a light source of light weight and versatile configuration to fully utilize the users needs while camping, hiking, and/or exploring. This light system is made up of three major components; 1 the head light unit, 2 the adjustable elastic straps, and 3 the battery pack. 1 The headlight is lit by twenty 4 LED(light emitting diode) bulbs. 1 The headlight is operated by a 5 four position, push-button switch. 5 The switch has an on-off position, four bulb light, twelve bulb light, and all twenty bulb light positions. 1 the head light unit has three retention tabs that interlock with opposing tab hooks on the 3 battery pack. These 6 tab and hook closures enable the two halves to be joined to accommodate the unit's two lamp configurations. The 3 the battery pack's backing plate is permanently affixed to the 2 adjustable elastic straps. The backing plate and the rest of the 3 battery pack is held together by a strategically placed screw, preferably centered horizontally and slightly higher centered vertically. The wires that bring the power from the 3 battery pack to the 1 head light unit travel through an 7 elastic tube that travels along the center of the upper 2 elastic strap. The 7 elastic tube contains a plastic tube to aid in the movement and installation of the power wires. Located at the posterior end of the 7 elastic tube is an 8 elastic holding pouch to hold excess wire length to allow room to adjust the upper 2 elastic strap.

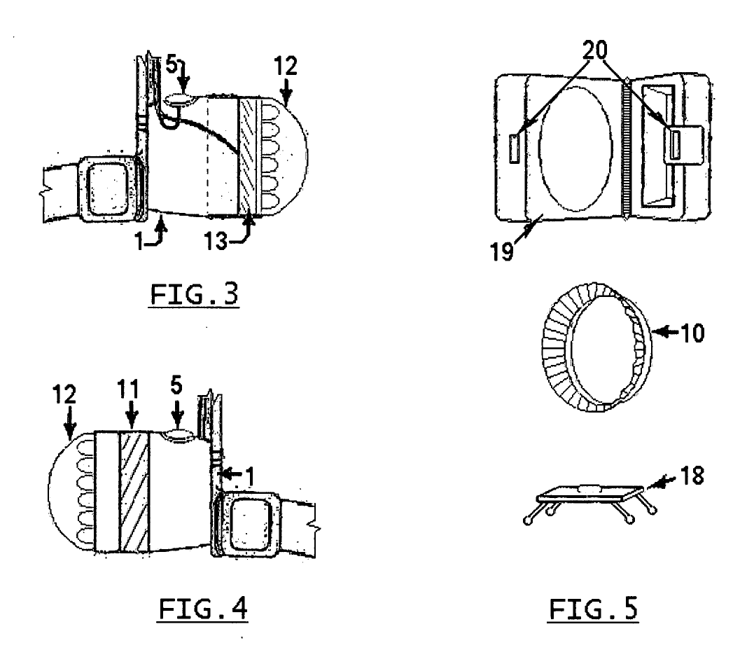

The 1 head light unit has two interchangeable lense covers. FIG. 1 shows the 9 spot light lense cover. This lense cover is approximately two to two and a half inches long and has a very highly reflective interior surface. This lense cover allows for maximum light dispersion for excellent exploring capabilities, such as needed in caves. The second lense cover is a 10 corrugated lamp shade and is used in either a hanging lamp or standing table lamp configuration. These two lense covers can be attached to the 1 headlight unit by means of 11 external threads as shown in FIG. 4. The 12 lense of this 1 headlight unit is attached by means of 13 internal treads as shown in FIG. 3. FIG. 3 also shows the interior view of 1 the headlight and it's wiring. The wires connect battery power to the 4 LED bulbs through the 5 four position switch.

FIG. 2 shows the rear view of the 3 battery box. The 3 battery box has a 14 raised area about one eighth to three sixteenths in depth. This 14 raised area contains a 15 U-shaped hook utilizing the whole light system to hang in it's hanging lamp configuration. FIG. 6 shows the 15 U-shaped hook in it's open position. The 15 U-shaped hook is held closed and level within the 14 raised area by two 16 tiny retention nodules located on the bottom and both sides of the 15 U-shaped hook. The 14 raised area also contains a 17 retention hole that allows the 18 lamp stand to snap into place with the light system. This allows the whole light system to stand in it's standing lamp configuration.

FIG. 5 shows the small accessory pack contains the 18 four legged lamp stand and either one of the 9 or 10 lense covers that is not in use. Its construction is composed of a rugged, impact resistant material. The interior contains an impact resistant foam that securely and protectively holds the accessory pieces in place when not in use. The accessory pack is primarily made of two halves hinged together and secured in a closed position by a 20 hook and tab closure or by any other array of subsequent type closures. This accessory pack may be equipped with a clip to attach the pack to either the belt or to some other place utilized by the user.

1. The EXPLORER LITE EXTREME has three major components, the headlight unit, adjustable elastic straps, and a specially designed battery box.

2. The EXPLORER LITE EXTREME has a battery box that contains a raised area. Within the raised area is a U-shaped hook and small retention hole.

3. The EXPLORER LITE EXTREME has an upper adjustable elastic strap that has an attached elastic tube that allows wire to be inserted through.

4. The EXPLORER LITE EXTREME has three hook and tab closures that enable the front and back half to joined together for either of it's lamp configurations.

5. The EXPLORER LITE EXTREME has a four position, push button on switch, a four bulb on, twelve bulb on, twenty bulb on, and off.

6. The EXPLORER LITE EXTREME has internal threads in the headlight unit to enable the slightly domed lense to be removed and attached.

7. The EXPLORER LITE EXTREME has external threads on the headlight unit to enable the two interchangeable lense covers to be removed and attached.

8. The EXPLORER LITE EXTREME has an accessory kit which contains the EXPLORER LITE EXTREME lamp stand and either lense cover that is not in use.

9. The EXPLORER LITE EXTREME has an interchangeable two to two and a half inch long spotlight lense cover that has a highly reflective interior surface

10. The EXPLORER LITE EXTREME has an interchangeable corrugated lense cover to be used in it's two lamp configurations.
